(19) United States
(12) Patent Application Publication
(10) Pub. No.: US 2011/0095985 A1
(43) Pub. Date: Apr. 28, 2011

(54) Computer keyboard emergency function key

(76) Inventor: Peter Cordani, Palm Beach Gardens, FL (US)

(21) Appl. No.: 12/607,483

(22) Filed: Oct. 28, 2009

(51) Int. Cl. G06F 3/02

(52) U.S. Cl. 345/168

(57) ABSTRACT

A computer keyboard function key conversion kit provides the necessary software connections to allow ease of calling an emergency responder through a keyboard, and a modified function key that both highlights the function key operation and makes the function key resistant to accidental depression. In one embodiment, a conventional computer that is connected to the internet is programmed with an emergency contact number that can be dialed upon the press of a function key. The function key is capped with a device that inhibits accidental operation of the function key. The function key may have a rigid body that requires a force to depressing, the force can be sufficient to cause destruction of the protector in a similar way the operation of a fire alarm causing destruction of the fire alarm. The device can be installed on a new computer or a currently installed computer.

### FIELD OF THE INVENTION

This invention relates to emergency calling devices and in particular to a computer keyboard emergency function key that can be used to reach first responders through an internet connection.

### BACKGROUND OF THE INVENTION

While an emergency can occur at most any time, the more time an individual spends performing a particular function, the more likely that an emergency may occur during that time span performing that function. In modern society, many individuals spend over eight hours a day working on a computer terminal. The use of the computer terminal may be work related such as data processing, word processing, programming, data entry or the like. Non-work related time may be spent on the computer terminal for internet browsing, social networking, and so forth. In any event, the more time an individual spends connected to a computer, the more time a health or emergency related issue may occur during that period.

The advent of computers has effectively created an environment that is conducive to an individual being placed near a computer during most all waking hours, as the computer has become for many individual the sole source of communication whether it be e-mail communication, product purchasing, school and business research, web based telephones, all of which depend upon a computer coupled to the internet. The use of computers has also created an environment where the operators do not maintain a high level of cardio activity, yet the stress level may be extremely high, and thus it is possible for individuals to have health related issues while working at a computer site. For instance, while an individual may have a phone available, a stroke or other medical emergency may not allow for the individual to reach the phone and call for help. If an individual is working at a computer terminal and hears someone breaking into their home, the individual may not have time to reach the phone and call for help. If a child is near an emergency, the child may not be able to understand the significance of a telephone call and proper use of a 911 connection.

There are numerous ways to contact an emergency service provider, the most common being the dialing of 911 on a telephone. In fact, use of a 911 number has become commonplace in the United States and eliminates the confusion of having to know a local telephone number for a fireman, policeman, hospital, or so forth. Further, unlike use of simply dialing an operator, the 911 service provider specializes in providing emergency service and is equipped with training to assist communication to the individual such as basic lifesaving techniques that the individual can use while waiting for the first responders.

In many instances, a telephone may not be available to an individual who is on-line. For instance, the phone line could be disabled as it is connected to the computer. Or in other instances, an individual may only have access to a cell phone as their computer is coupled to a cable TV line or a satellite line

Thus, what is lacking in the art is an emergency device that can be incorporated into a conventional computer allowing the contacting of an emergency service provider or the equivalent thereof.

### DESCRIPTION OF THE PRIOR ART

U.S. Published Patent Application No. 2007/0206728, filed by Volpentesta, discloses a computer integrated fire safety system which enables a user to contact the fire and/or police department in the event of a fire and/or an emergency. There are “panic buttons” on the computer keyboard. Activation of these buttons utilizes biz intelligent software to inform the authorities of the emergency and the location of the computer.

U.S. Published Patent Application No. 2007/0103317 filed by Zellner, discloses a method and apparatus to access emergency services over the Internet. A panic button 24 may be a push button or a key similar to a key on a computer keyboard. A microphone 34 and speaker 32 can be employed to communicate with an emergency service center over the Internet.

U.S. Published Patent Application No. 2005/0172022, filed by Brown, provides a means for receiving medical attention via communication carried via a computer based system.

### SUMMARY OF THE INVENTION

The instant invention is a computer keyboard conversion kit that provides the necessary software connections to allow ease of calling an emergency responder by depressing a keyboard function key. The modified function key highlights the function key operation and makes the function key resistant to accidental depression. In the preferred embodiment, a conventional computer that is connected to the Internet is programmed with an emergency contact number that is automatically dialed upon the activation of a function key. The function key is capped with a device that emphasizes the criticality of the function key with an optional cap to inhibit accidental operation of the function key. The function key may have a rigid protector body that requires a force to depress, such force required to depress the function key can be sufficient to cause destruction of the rigid protector body in a similar way the operation of a fire alarm causing destruction of the fire alarm.

The device can be installed on a new computer or on an existing computer. The preferred embodiment is a kit which includes software, a label for a key on a keyboard and a microphone which enables a computer to be retrofitted with an emergency call function.

An objective of the invention is to disclose the use of a conventional computer keyboard for use in contacting an emergency service provider or the equivalent thereof.

A further objective of the invention is a kit which includes software, a label for a key on a keyboard, a microphone and enrollment in a service which monitors you and your home/business and can contact an emergency provider at your request.

Still another objective of the invention is to disclose the use of a keyboard conversion kit that includes a function key cover that inhibits accidental depressing.

Another objective of the invention is to teach the use of a preprogrammed function key on a conventional computer keyboard for contacting of an emergency responder.

Yet another objective of the invention is to disclose the use of an emergency function key which may be capped with a protective cover such as a frangible guard, retro-fitted, deformable cap, or the like.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a schematic illustration of a first embodiment of the present invention;

FIG. 2 illustrates the elements in a kit of the present invention;

FIG. 3 illustrates an alternative embodiment of the elements in a kit of the present invention;

FIG. 4 illustrates an alternative embodiment of the elements in a kit of the present invention;

FIG. 5 is a schematic illustration of another embodiment of the present invention;

FIG. 6a is an illustration of the preferred embodiment of the emergency function key;

FIG. 6b is a cross-sectional view of FIG. 4a of the preferred embodiment of the emergency function key in use; and

FIGS. 6c-6d are illustrations of various embodiments of the emergency function key.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

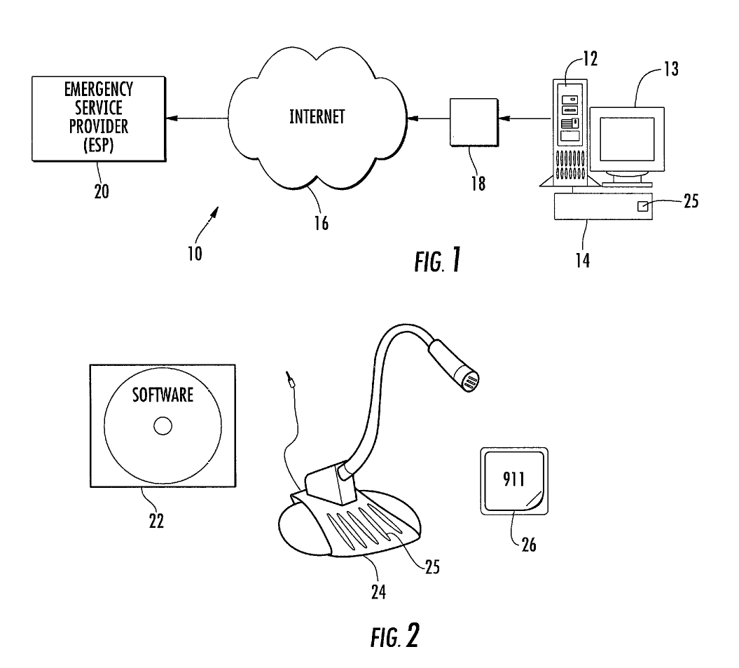

With reference to FIGS. 1-4 the present invention will now be described. Like reference numerals refer to like elements in the different figures. FIG. 1 illustrates a first preferred embodiment of the present invention 10. A computer 12 includes an input device such as a keyboard 14. The computer is coupled to the Internet 16 utilizing an Internet Protocol (IP) device 18 such as a modem. It should be noticed that computers are coupled to the internet by a variety of connections including cable (e.g. DSL), satellite, telephone, fiber optic, radio frequency, infrared, and so forth. The IP device 18 enables the computer 12 to communicate over the Internet 16 to various other web sites. The IP device 18 may connect to the Internet 16 utilizing a TCP/IP (Transmission Control Protocol/Internet Protocol) for example. An Emergency Service Provider (ESP) 20 is also connected to the Internet 16 utilizing an IP device 18. The Emergency Service Provider 20 can be a fire station, a police station, a hospital, a private security company, etc. A person at the emergency service provider 20 communicates with the person requesting the emergency service preferably utilizing voice communication.

The preferred embodiment of the present invention is a kit which includes software 22, which is loaded onto a computer 12, a microphone 24 and a label 26 as illustrated in FIG. 2. The software is loaded onto a computer 12 which is to be used to contact the emergency services contemplated by the user. The information to be loaded as part of the programming step includes the individual's name, location, health information, and emergency contacts such as spouse, parent, doctor, or neighbor. The information is preferably placed in the non-volatile portion of the computer memory. However, information may also be stored temporarily to meet a particular situation. For instance, the user may deem the use of a 911 responder as the most suitable responder. The software would then be used to program a function key to make all necessary connections to the 911 responder in the event a preprogrammed function key is depressed during an emergency. The software could also be used to program a function key to make all necessary connections to reach a doctor, a parent, a next door neighbor, a paid watch service such as ADT® (telecommunication service, namely, providing access to images, video, alarm status, building plans and other building and security information at a remote station) or BRINKS® (security alarm and monitoring system services). Alternatively, if a parent employs a “babysitter” while they are out of the home, the emergency contact information may be a neighbor's telephone wherein the information can be stored in a volatile memory for temporary use. Alternatively the program may connect the computer to another individual carrying a PDA capable of receiving e-mails, such as a BLACKBERRY® (telecommunication equipment electronic handheld unit for wireless receipt and transmission of data). Further, the program allows the operator (in this example the parent) to program a number of contacts which are called simultaneously. For instance, the babysitter may initiate a panic call wherein the emergency call is made to the police, a next door neighbor, as well as the parent. The open connection may be made to the police only while the neighbor and parent can listen to the call.

A microphone 24 is connected to the audio input of the computer 12 which can be used as an open microphone for communication with the responder. For instance, if the responder was a neighbor the microphone would allow the neighbor to hear what was happening. The microphone 24 may include a speaker function 25 to allow the user to hear the responder.

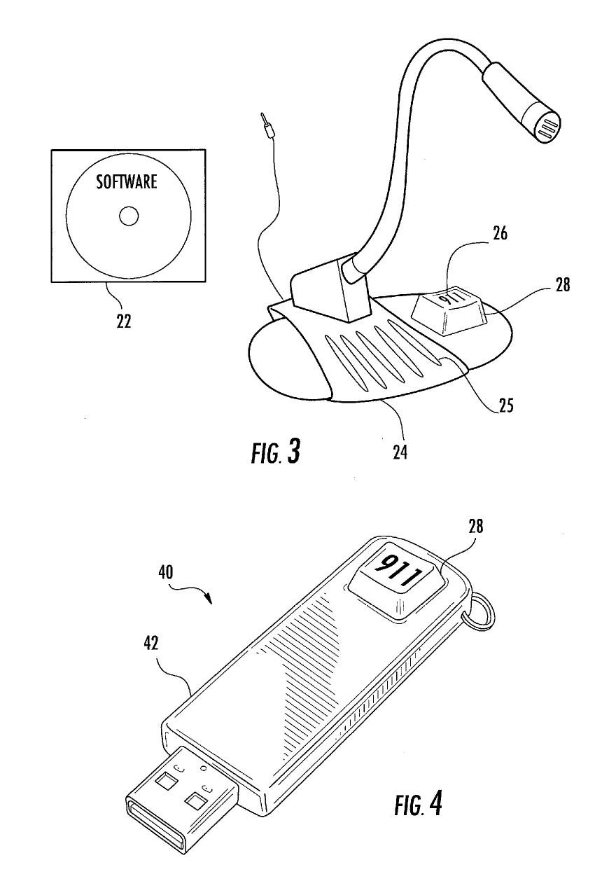

A label 26 is placed onto a specific key on the keyboard 14 of the computer 12 to indicate the emergency function key 28. The label may be marked “emergency” “911” or the like indicia so as to indicate and highlight the special use of the function key. The software 22 assigns a specific function to the key which an individual selects as part of the programming step. The programmed function key 28 will then connect the keyboard operator to an emergency service provider when the emergency function key 28 is depressed. Once the connection with the emergency service provider is established an individual at the computer 12 can speak to an emergency service provider utilizing the microphone 24 and speaker, which many computers are provided with, or can be included as part of the kit. Depending upon the type of emergency service provider employed, the provider can determine the nature of the emergency, the location of the individual requesting the emergency service and the severity or degree of the emergency. The programming of the function key would include the individual inserting the location of the computer, directions to the home or business, emergency contact information such as a spouse, parent, doctor, or relative. Portable laptops having GPS capability may include a location finder so as to provide the first responder with the location of the laptop during the emergency transmission. Furthermore, the kit may include a microphone having an emergency function key thereon, whereby the emergency function key operates just as described above when the microphone is connected the computer, as shown in FIG. 3. The use of an existing keyboard having function keys would not be necessary for use of the emergency function key 28, as the emergency function key is affixed to the microphone 24.

In the event that the individual requesting the emergency service cannot speak or the individual's hearing is impaired, the software can enable the individual to utilize the monitor 13 and the keyboard 14 of the computer to communicate with the emergency service provider. For example, when the emergency service answers the call from an individual requiring the emergency service, the software 22, which has been loaded onto the individual's computer, can prompt and/or notify the emergency provided to communicate with the individual requesting the emergency service utilizing the keyboard on the emergency service provider's computer. In addition to a keyboard, other input devices can be employed that will provide a visual message at the computer of the individual requesting the emergency service. One of the many alternative inputs would be voice recognition; another alternative input would be a video camera or web camera.

Also contemplated is the use of an emergency function key 28 in combination with an external hard-drive 40 such as a flashdrive, thumbdrive, or the like, as shown in FIG. 4. The emergency function key 28 would function just as described above with the exception of the emergency function key 28 being external to the existing keyboard or microphone. The software 42 would be embedded into the external hard-drive 40. The software 42 would then be used to program a function key 28 to make all necessary connections to the 911 responder in the event a preprogrammed function key is depressed during an emergency. The software 42 could also be used to program a function key 28 to make all necessary connections to reach a doctor, a parent, a next door neighbor, a paid watch service such as ADT® (telecommunication service, namely, providing access to images, video, alarm status, building plans and other building and security information at a remote station) or BRINKS® (security alarm and monitoring system services), as described above.

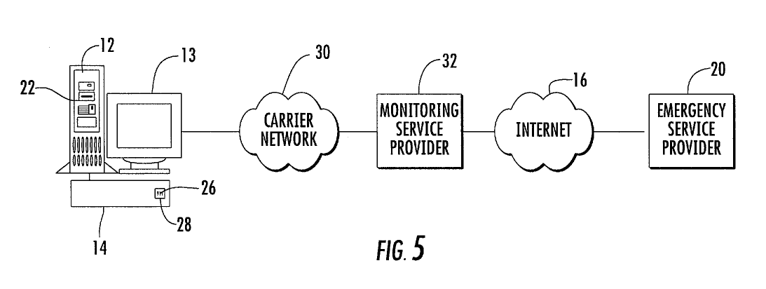

Another embodiment of the present invention, illustrated in FIG. 5, again a kit including a software package 22 installed on an individual's computer 12. The software package 22 operates in conjunction with a special key 28 on the computer keyboard 14. This key 28 is selected by the individual and identified as an emergency function key. A label 26 is placed on the key 28 to identify it. Whenever the emergency function key 28 is pressed the software sends a message over a carrier network 30, e.g. public switched telephone network (PSTN) to a service 32 which monitors an individual's home or business and contacts the proper emergency services in the event of an emergency in a similar format that ADT® or BRINKS® monitor property security. The service 32 can contact the individual to determine the nature of the emergency or the service can automatically contact an emergency service provider 20, such as the fire or police department over the Internet 16.

The software 22 enables the individual to preprogram how the system will respond to the activation of the emergency function key 28. In one instance the monitoring service 32 calls or contacts the individual requesting the emergency service to determine the nature of the emergency. In another instance, the system can be programmed to have the monitoring service contact a specific emergency service provider 20 whenever the emergency function key 28 is activated.

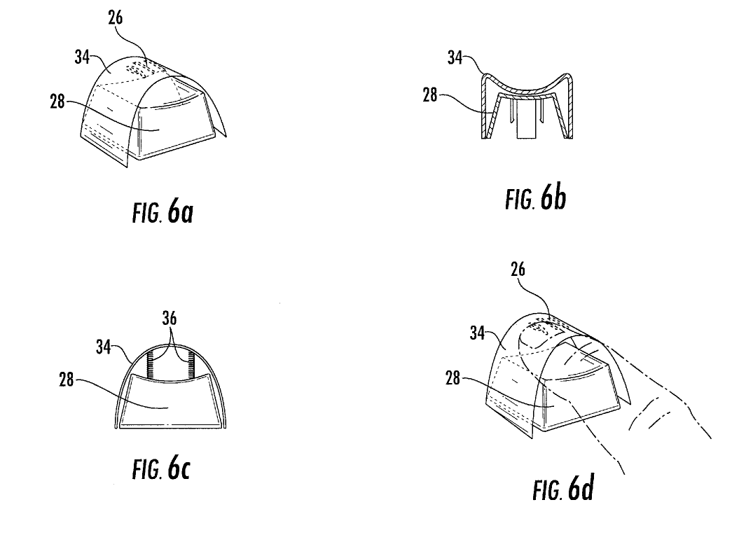

Referring to FIGS. 6a-6d, an element or cap 34 can be placed on top of the emergency function key 28 which prevents accidental activation of the emergency function key and also provides and indication that the emergency function key 28 was purposely activated. In a preferred embodiment, FIG. 6a, element 34 can be a frangible cap wherein significant pressure must be applied to break the cap 34 and activate the key 28 positioned beneath cap 34. The frangible cap may be a tin cover having a convex top wherein sufficient pressure to the cover would cause a collapse of the cover for operation of the function key, as shown in the cross-sectional view of FIG. 6b. In yet another form, the cap 34 could be made from a flexible foil, such as aluminum foil. Enough pressure must be applied to the foil cap to crush the foil which in turn would activate the emergency function key 28. Once the foil has been crushed or deformed by activation it will not return to its original shape. Furthermore, the cap 34 may be of a vibrant color to highlight or alert the user of the presence of the function key 28. Alternatively the cap 34 may include a belleville spring 36 where enough pressure must be applied to activate the spring 36 which in turn would activate the emergency function key 28, as shown in FIG. 6c. The belleville spring 36 can be made to return to its original shape or more preferably the collapse of the spring 36 will not return to its original shape. This would then be an indication that the emergency function key 28 had been activated. An alternative embodiment of the cap 34, shown in FIG. 6d, provides a protective guard surrounding the function key 28, which allows significant room for a finger to be placed between the function key 28 and the guard 34 for depressing the function key 28. Other types of elements can also be employed. The only criterion for these other elements is that they provide evidence that the emergency function key was activated or pushed.

Furthermore, the cap may include an audio device whereupon depression an audio noise is emitted. The audio noise may act as a deterrent to thieves, just as an alarm system would, or the audio noise may act as an indicator to the user or others nearby that the function key 28 has been activated.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A kit for use in combination with a computer coupled to the internet for converting a function key of a conventional desktop or laptop computer keyboard to a responder contact function key comprising:
a software program for programming a function key on the desktop computer keyboard, said software program responsive to the depression of the programmed function key for connecting said computer to a preselected responder by use of the internet;
a frangible cap for placement over said programmed keyboard function key, said frangible cap including indicia for indicating special emergency only operation of the programmed function key; and
a microphone operatively associated with a computer, said microphone enabling an individual to communicate with an emergency responder after said function key is activated.

2. The kit of claim 1 wherein said indicia is an element which provides an indication that said function key has been activated.

3. The kit of claim 1 wherein said frangible cap is constructed and arranged to require significantly more pressure that normally required to activate a key on a keyboard, said cap deforming upon activation and not returning to the original shape of said cap whereby an indication that said key had been activated.

4. The key of claim 3 wherein said cap is constructed from metallic foil.

5. The kit of claim 1 wherein said frangible cap is constructed and arranged to require significantly more pressure that normally required to activate a key on a keyboard, said cap deforming upon activation and returning to the original shape of said cap for reuse.

6. The key of claim 5 wherein said cap includes a Belleville spring

7. The kit of claim 1 wherein said software enables nonverbal communication between an individual and an emergency service provider.

8. The kit of claim 4 wherein said nonverbal communication comprises text on a computer monitor and input from a keyboard.

9. The kit of claim 1 wherein said responder is a public emergency responder.

10. The kit of claim 1 wherein said computer connects to multiple responders.
